(19) United States
(12) Patent Application Publication
(10) Pub. No.: US 2022/0203300 A1
(43) Pub. Date: Jun. 30, 2022

(54) METHOD FOR CLEANING SULFUROUS CORROSIVE PROCESS GASES

(71) Applicant: COVESTRO INTELLECTUAL PROPERTY GMBH & CO.KG, Leverkusen (DE)

(72) Inventors: Alexander LUEKEN, Kaarst (DE); Michael VENZ, Dormagen (DE); Thomas BURBACH, Bedburg (DE); Andre RITTERMEIER, Bochum (DE)

(21) Appl. No.: 17/605,697

(22) PCT Filed: Apr. 23, 2020
(86) PCT No.: PCT/EP2020/061323

§ 371 Date: Oct. 22, 2021

(30) Foreign Application Priority Data
Apr. 26, 2019 (EP) 19171249.6

(51) Int. Cl. B01D 53/86; B01J 21/06; B01J 23/10

(52) U.S. Cl. CPC B01D 53/8609; B01D 53/8615; B01D 53/8659; B01J 21/066; B01D 2257/308; B01D 2255/2065; B01D 2257/204; B01D 2257/302; B01D 2257/304; B01J 23/10

(57) ABSTRACT

The invention relates to a method for cleaning corrosive process gases that contain sulfur compounds. According to the method, a gas stream that contains corrosive gases is conducted, in a sorption phase, over an inorganic sorbent material which absorbs at least one of the sorbable sulfurous components on the sorbent material, and the sulfurous compound-depleted gas stream is removed.

The invention relates to a process for purifying sulfur-containing corrosive process gases.

The invention further relates to the use of zirconium oxide- and/or cerium oxide-containing inorganic sorption media for removing sulfur compounds from sulfur-containing corrosive process gases.

The invention proceeds from purifying processes for corrosive and in particular hydrogen chloride-containing process gases which are known per se.

WO2015198567 discloses a means for removing sulfur from liquids in a purification column containing copper, silver or iron, in particular copper particles, as reactive components. The purifying of corrosive gases is not mentioned in this document.

WO2015085880 discloses a process for removing SOₓ from gases in which a polyethylene glycol solution is employed as the adsorption medium. This adsorption medium may be regenerated by degassing.

DE1645817 discloses a process for desulfurizing crude oil in which the crude oil is mixed with water and hydrogen and the resulting mixture is contacted with a catalyst mass under desulfurization conditions. The catalyst mass is a supported catalyst comprising a catalytic component composed of at least one metal from groups VIa and VIII of the periodic table on an argillaceous earth-silica support. Catalysis is carried out in the presence of hydrogen. Desulfurization of corrosive raw gases is not disclosed here.

The present invention has for its object to provide a purifying process for corrosive process gases containing sulfur compounds which overcomes the abovementioned disadvantages and allows sulfur compounds to be removed from the process gases to the greatest possible extent.

It is especially an object of the invention to provide a gas purification process which avoids the disadvantages of the known purification processes and in particular allows purification of process gases for catalytic gas phase oxidation of hydrogen chloride, thus avoiding poisoning of the catalyst for the gas phase oxidation.

The object is achieved when the corrosive process gas stream is passed over a chemically inert inorganic sorption medium which absorbs the sorbable sulfur-containing components.

The present invention provides a process for purifying corrosive process gases containing sulfur compounds, characterized in that a gas stream comprising corrosive gases is in a sorption phase at a defined temperature passed over a sorption material which takes up at least one of the sorb able sulfur-containing components on the sorption material to discharge the gas stream depleted of sulfur compounds.

The takeup of the sorbable sulfur-containing components may in principle be effected via an adsorption process or an absorption process.

The novel process preferably comprises as sulfur compounds one or more compounds from the group of: SOₓ, preferably SO₂ and SO₃, H₂S, CS₂, SOCl₂, S₂Cl₂, SCl₂, COS and mercaptans.

The novel process is especially suitable for the purification of gas mixtures in which the sulfur compounds are present as trace gas, in particular in a concentration of not more than 10 ppm, preferably not more than 1 ppm, particularly preferably not more than 0.1 ppm.

In a preferred embodiment of the novel process the sorption material comprises as the active component at least one oxide or mixed oxide of cerium and/or zirconium and/or titanium, particularly preferably CeO₂ and/or ZrO₂ and/or TiO₂.

Suitable support materials for the sorption medium are, in particular, all generally known support materials that are chemically resistant to hydrogen chloride, in particular one or more support materials from the group of: Al₂O₃, TiO₂, ZnO₂, SiO₂, SnO₂ and ZrO₂, wherein the support material and any active component of the sorption material are different.

Suitable materials for the support particularly preferably include Al₂O₃, TiO₂, ZrO₂.

In a preferred embodiment of the novel purification process the sorption medium comprises a supported cerium oxide catalyst which is especially obtained when a cerium compound and in particular a compound from the group of: cerium nitrate, cerium acetate or cerium chloride in solution is applied to the support by means of dry impregnation and the impregnated support is subsequently dried and calcinated at elevated temperature.

Dry impregnation is in the present case especially to be understood as meaning that the component to be applied is dissolved only in sufficient solvent that this solvent is completely taken up by the support material.

A dry sorptive support material is here impregnated with a liquid yet a dry material is nevertheless obtained since the sorptive capacity of the support is greater than the employed liquid quantity.

The novel process is preferably performed such that the purification of the corrosive process gas is effected at a temperature of not more than 420° C., preferably not more than 200° C., particularly preferably not more than 40° C.

The purification of the corrosive process gas is preferably performed at elevated pressure especially of at least 1013 hPa, preferably at least 2026 hPa to 25.325 hPa.

The purification process is preferably controlled such that the gas stream depleted of sulfur compounds has a residual content of sulfur compounds of not more than 0.05 ppm, preferably not more than 0.01 ppm, particularly preferably not more than 1 ppb.

In a preferred embodiment of the novel process the corrosive process gas comprises as the corrosive component at least hydrogen chloride or hydrogen chloride and chlorine. Furthermore, inert components may be present in the corrosive process gas, for example nitrogen and carbon dioxide.

In a preferred embodiment the novel purification process is coupled to a downstream catalyzed process, in particular for conversion of the corrosive gases. The gas stream depleted of sulfur compounds is particularly preferably sent to a downstream catalytic process, preferably a catalytic oxidation reaction, particularly preferably a thermocatalytic oxidation of hydrogen chloride gas.

The preferred above described coupled process mode is in a preferred variant of the novel process performed such that the gas purification of the corrosive process gas is performed in a reaction zone arranged in a reactor which is separate from a downstream further reactor and whose temperature and/or pressure may be controlled independently of the further reactor.

In a preferred variant the gas purification of the corrosive process gas is performed in a reaction zone arranged in a reactor having a plurality of reaction zones, wherein the reaction zone for purification is separate from at least one further downstream reaction zone for the gas phase reaction and the temperature and/or the pressure in the reaction zone for gas purification may be controlled independently of the downstream reaction zone.

It is preferable when, as described hereinabove, the catalytic process known as the Deacon process is employed. In this process hydrogen chloride is oxidized with oxygen in an exothermic equilibrium reaction to afford chlorine while generating steam. The reaction temperature is typically 150° C. to 500° C. and the customary reaction pressure is 1 to 25 bar. Since the reaction is an equilibrium reaction, it is appropriate to operate it at the lowest possible temperatures at which the catalyst still has a sufficient activity. It is further advantageous to use oxygen in superstoichiometric amounts relative to hydrogen chloride. A two- to four-fold oxygen excess, for example, is typical. Since there is no risk of any selectivity losses, it may be economically advantageous to operate at relatively high pressure and correspondingly with a longer residence time relative to standard pressure.

Suitable preferred catalysts for the Deacon process contain ruthenium oxide, ruthenium chloride, ruthenium oxychloride or other ruthenium compounds on silicon dioxide, aluminum oxide, titanium dioxide, tin dioxide or zirconium dioxide as a support. Suitable catalysts are obtainable for example by application of ruthenium chloride to the support and subsequent drying or drying and calcining. In place of or in addition to a ruthenium compound suitable catalysts may also contain compounds of other noble metals, for example gold, palladium, platinum, osmium, iridium, silver, copper or rhenium. Suitable catalysts may also contain chromium(III) oxide.

The catalytic hydrogen chloride oxidation may be performed either adiabatically or isothermally or virtually isothermally, but preferably adiabatically, discontinuously or continuously, but preferably continuously, as a fluidized bed or fixed bed process, preferably as a fixed bed process, particularly preferably in tube bundle reactors over heterogeneous catalysts at a reactor temperature of 180° C. to 500° C., preferably 200° C. to 400° C., particularly preferably 220° C. to 350° C., and a pressure of 1 to 25 bar (1000 to 25 000 hPa), preferably 1.2 to 20 bar, particularly preferably 1.5 to 17 bar and in particular 2.0 to 15 bar.

Typical reaction apparatuses in which the catalytic hydrogen chloride oxidation is performed are fixed bed or fluidized bed reactors. The catalytic hydrogen chloride oxidation can preferably also be performed in a plurality of stages.

In the adiabatic procedure it is also possible to employ a plurality, in particular 2 to 10, preferably 4 to 8, particularly preferably 5 to 7, of serially connected reactors with intermediate cooling. In the isothermal or virtually isothermal procedure it is also possible to employ a plurality, i.e. 2 to 10, preferably 2 to 6, particularly preferably 2 to 5, in particular 2 to 3, of serially connected reactors with additional intermediate cooling. The hydrogen chloride may be added either entirely upstream of the first reactor together with the oxygen or such that it is distributed over the various reactors. This serial connection of individual reactors can also be combined in one apparatus.

A further preferred embodiment of an apparatus suitable for the Deacon process consists in using a structured catalyst bed in which the catalyst activity increases in the flow direction. Such a structuring of the catalyst bed can be accomplished through varying impregnation of the catalyst supports with active mass or through varying dilution of the catalyst with an inert material. Employable inert materials are for example rings, cylinders or spheres of titanium dioxide, tin dioxide, zirconium dioxide or mixtures thereof, aluminum oxide, steatite, ceramic, glass, graphite or stainless steel. In the case of the preferred use of shaped catalyst bodies, the inert material should preferably have similar external dimensions.

Suitable heterogeneous catalysts are particularly ruthenium compounds or copper compounds on support materials, which may also be doped, preference being given to optionally doped ruthenium catalysts. Suitable support materials are, for example, silicon dioxide, graphite, titanium dioxide having a rutile or anatase structure, tin dioxide, zirconium dioxide, aluminum oxide or mixtures thereof, preferably titanium dioxide, tin dioxide, zirconium dioxide, aluminum oxide or mixtures thereof, particularly preferably tin dioxide, α- or γ-aluminum oxide or mixtures thereof.

The supported copper or ruthenium catalysts may be obtained, for example, by impregnating the support material with aqueous solutions of CuCl₂ or RuCl₃ and optionally a promoter for doping, preferably in the form of its chloride. The forming of the catalyst can be carried out after or preferably before impregnating the support material. In addition to a ruthenium compound suitable catalysts may also contain compounds of other noble metals, for example gold, palladium, platinum, osmium, iridium, silver, copper, chromium or rhenium.

For doping of the catalysts suitable promoters are metals or metal compounds of the metals: alkali metals such as lithium, sodium, potassium, rubidium and cesium, preferably lithium, sodium and potassium, more preferably potassium, alkaline earth metals such as magnesium, calcium, strontium and barium, preferably magnesium and calcium, more preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

Suitable shaped catalyst bodies include shaped bodies with any desired forms, preference being given to tablets, rings, cylinders, stars, wagon wheels or spheres, particular preference being given to rings, cylinders or star extrudates, as the form.

The shaped bodies may then be dried at a temperature of 100 to 400° C., preferably 100 to 300° C., for example under an atmosphere of nitrogen, argon or air, and may be optionally calcined. The shaped bodies are preferably initially dried at 100 to 150° C. and subsequently calcined at 200 to 400° C.

The conversion of hydrogen chloride in a single pass may preferably be limited to 15% to 90%, preferably 40% to 85%, particularly preferably 50% to 70%. Unconverted hydrogen chloride may, after separation, be partly or fully recycled into the catalytic hydrogen chloride oxidation. The volume ratio of hydrogen chloride to oxygen at the reactor inlet is preferably from 1:1 to 20:1, preferably 1:1 to 8:1, more preferably 1:1 to 5:1.

The heat of reaction of the catalytic hydrogen chloride oxidation may advantageously be utilized to generate high-pressure steam. This steam can be utilized to operate a phosgenation reactor and/or distillation columns, especially isocyanate distillation columns.

The invention further provides for the use of a sorption material which comprises as the active component at least one oxide or mixed oxide of cerium and/or zirconium, preferably CeO₂ and/or ZrO₂, for removal of sulfur compounds from corrosive process gas containing sulfur compounds, in particular from corrosive process gas containing at least hydrogen chloride or hydrogen chloride and chlorine.

### EXAMPLES

### Example 1

To produce a sorption medium for sulfur compounds a ZrO₂-support material (manufacturer: Saint-Gobain NorPro; type: SZ 31163; extrudates of 3-4 mm in diameter and 4-6 mm in length) of monoclinic structure and having the following specifications (before mortaring) was employed:
specific surface area of 55 m²/g (nitrogen adsorption, BET evaluation)
bimodal pore radius distribution, wherein a pore class 1 (transport pores) has a median of 60 nm and a pore class 2 (fine pores) has a median of 16 nm (mercury porosimetry)
pore volume of 0.27 cm³/g (mercury porosimetry)
bulk density of 1280 kg/m³ (measured in a DN100 measuring cylinder of 350 mm in height)

This ZrO₂ support material (SZ 31163) was crushed with a mortar and classified into screen fractions. 1 g of the 100-250 μm screen fraction was dried at 160° C. and 10 kPa for 2 h. 50 g of cerium(III) nitrate hexahydrate were dissolved in 42 g of deionized water. 0.19 ml of the thus produced cerium(III) nitrate solution was initially charged in a snap-lid bottle having been diluted with an amount of deionized water sufficient to fill the total pore volume and 1 g of the dried screen fraction (100-250 μm) of the ZrO₂ catalyst support was stirred in until the initially charged solution was fully absorbed (dry impregnation methodology). The impregnated ZrO₂ catalyst support was then dried at 80° C. and 10 kPa for 5 h and then calcinated in a muffle furnace in air. To this end, the temperature in the muffle furnace was increased linearly from 30° C. to 900° C. over 5 h and held at 900° C. for 5 h. The muffle furnace was then cooled linearly from 900° C. to 30° C. over 5 h. The amount of cerium supported corresponds to a proportion of 7% by weight based on the calcined catalyst, calculating the catalyst components as CeO₂ and ZrO₂.

### Example 2

0.5 g of the sorption medium prepared in example 1 was initially charged in a fixed bed in a quartz reaction tube (internal diameter 8 mm) and at a temperature of 20° C. subjected to a gas mixture flow of 2 L/h of hydrogen chloride, 1 L/h of oxygen, 2 L/h of nitrogen and 5 ppm of SO₂ for 336 h. The sulfur content on the sorption medium was then determined by elemental analysis. The result is shown in table 1.

### Example 3

0.5 g of the sorption medium prepared in example 1 was initially charged in a fixed bed in a quartz reaction tube (internal diameter 8 mm) and at a temperature of 260° C. subjected to a gas mixture flow of 2 L/h of hydrogen chloride, 1 L/h of oxygen, 2 L/h of nitrogen and 5 ppm of SO₂ for 336 h. The quartz reaction tube was heated by an electrically heated oven. The sulfur content on the sorption medium was then determined by elemental analysis. The result is shown in table 1.

### Example 4

0.5 g of the sorption medium prepared in example 1 was initially charged in a fixed bed in a quartz reaction tube (internal diameter 8 mm) and at a temperature of 300° C. subjected to a gas mixture flow of 2 L/h of hydrogen chloride, 1 L/h of oxygen, 2 L/h of nitrogen and 5 ppm of SO₂ for 336 h. The quartz reaction tube was heated by an electrically heated oven. The S content on the sorption medium was then determined by elemental analysis. The result is shown in table 1.

### Example 5

0.5 g of the sorption medium prepared in example 1 was initially charged in a fixed bed in a quartz reaction tube (internal diameter 8 mm) and at a temperature of 340° C. subjected to a gas mixture flow of 2 L/h of hydrogen chloride, 1 L/h of oxygen, 2 L/h of nitrogen and 5 ppm of SO₂ for 336 h. The quartz reaction tube was heated by an electrically heated oven. The S content on the sorption medium was then determined by elemental analysis. The result is shown in table 1.

### Example 6

0.5 g of the sorption medium prepared in example 1 was initially charged in a fixed bed in a quartz reaction tube (internal diameter 8 mm) and at a temperature of 380° C. subjected to a gas mixture flow of 2 L/h of hydrogen chloride, 1 L/h of oxygen, 2 L/h of nitrogen and 5 ppm of SO₂ for 336 h. The quartz reaction tube was heated by an electrically heated oven. The S content on the sorption medium was then determined by elemental analysis. The result is shown in table 1.

### Example 7

0.5 g of the sorption medium prepared in example 1 was initially charged in a fixed bed in a quartz reaction tube (internal diameter 8 mm) and at a temperature of 420° C. subjected to a gas mixture flow of 2 L/h of hydrogen chloride, 1 L/h of oxygen, 2 L/h of nitrogen and 5 ppm of SO₂ for 336 h. The quartz reaction tube was heated by an electrically heated oven. The S content on the sorption medium was then determined by elemental analysis. The result is shown in table 1.

### Example 8

A commercially available CeO₂-doped ZrO₂ support material (manufacturer: Saint-Gobain NorPro; type: SZ 61191, 3 mm diameter spheres) of tetragonal structure and having the following specifications was employed:
18% CeO₂, remainder ZrO₂
specific surface area of 110 m²/g (nitrogen adsorption, BET evaluation)
bimodal pore radius distribution, wherein a pore class 1 (transport pores) has a median of 150 nm and a pore class 2 (fine pores) has a median of 4 nm (mercury porosimetry)
pore volume of 0.25 cm³/g (mercury porosimetry)
bulk density of 1400 kg/m³ (measured in a DN100 measuring cylinder of 350 mm in height)

The ZrO₂ catalyst support was tested and analyzed in the same way as the sorption medium in examples 2-7. The result is shown in table 1.

### Example 9

A commercially available ZrO₂ support material (manufacturer: Saint-Gobain NorPro; type: SZ 31152, 3 mm diameter spheres) of tetragonal structure and having the following specifications was employed:
specific surface area of 140 m²/g (nitrogen adsorption, BET evaluation)
bimodal pore radius distribution, wherein a pore class 1 (transport pores) has a median of 150 nm and a pore class 2 (fine pores) has a median of 3 nm (mercury porosimetry)
pore volume of 0.30 cm³/g (mercury porosimetry)
bulk density of 1100 kg/m³ (measured in a DN100 measuring cylinder of 350 mm in height)

The ZrO₂ catalyst support was tested and analyzed in the same way as the sorption medium in examples 2-7. The result is shown in table 1.

### Example 10

A ZrO₂ microparticle support material (manufacturer: Saint-Gobain NorPro, 0.781 mm diameter microparticles) of monoclinic structure and having the following specifications was employed:
specific surface area of 102 m²/g (nitrogen adsorption, BET evaluation)
bimodal pore radius distribution, wherein a pore class 1 (transport pores) has a median of 110 nm and a pore class 2 (fine pores) has a median of 8 nm (mercury porosimetry)
pore volume of 0.65 cm³/g (mercury porosimetry)
bulk density of 722 kg/m³ (measured in a DN100 measuring cylinder of 250 mm in height)
The ZrO₂ catalyst support was tested and analyzed in the same way as the sorption medium in examples 2-7.

The essential indices and results from the abovementioned examples are summarized in table 1 below.

TABLE 1

| Ex. | | BET | Sulfur [ppm] | | | | | | |
|---|---|---|---|---|---|---|---|---|---|
| # | Material | [m²/g] | unpoisoned | RT | 260° C. | 300° C. | 340° C. | 380° C. | 420° C. |
| 2-7 | CeO₂/ZrO₂ | — | 26 | 230 | 470 | 400 | 4400 | 5500 | 8900 |
| 8 | CeO₂/ZrO₂ | 110 | 88 | 470 | 420 | 700 | 89? | 3900 | 6300 |
| 9 | ZrO₂ | 140 | 120 | 260 | 88 | 1000 | 25500 | 200 | 14 |
| 10 | ZrO₂ | 102 | 22 | 140 | 19 | 200 | 940 | 600 | 5 |

### Example 11/12

Commercially available ZrO2 support materials (manufacturer: Saint-Gobain NorPro) of tetragonal structure having the following specifications were employed:

Type: SZ 61152, 3 mm diameter spheres (example 11):
Specific surface of 133 m²/g
Median pore diameter: 775 Å
Total pore volume of 0.30 cm³/g
Bulk density of 1240 kg/m³ type: SZ 31163, 3 mm diameter spheres (example 12):
Specific surface area of 57.2 m²/g
Median pore diameter: 171 Å
Total pore volume of 0.29 cm³/g
Bulk density of 1281.3 kg/m³

1 g of each sorption medium was initially charged in a fixed bed in a quartz reaction tube (internal diameter 8 mm) and at a temperature of 20° C. subjected to a gas mixture flow of 2 L/h of hydrogen chloride, 2.75 L/h of nitrogen and 100 ppm SO2, H₂S or COS for 168 h. The sulfur content on the sorption medium was then determined by elemental analysis. The result is shown in table 2.

TABLE 2

| | | Sulfur [ppm] | | | |
|---|---|---|---|---|---|
| | | | After SO₂ | After H₂S | After COS |
| Example | BET [m²g⁻¹] | unpoisoned | adsorption | adsorption | adsorption |
| 11 | 133 | 99 | 180 | 120 | 100 |
| 12 | 57.2 | 24 | 31 | 28 | 52 |

### CONCLUSIONS

The sorption properties of the materials vary markedly at different temperatures.

In the case of the pure ZrO₂ materials the sorption capacity is almost always below the sorption capacity of CeO₂-containing materials. In the case of the pure ZrO₂ materials the sorption capacity follows a linear trend with BET surface area. The higher the BET surface area, the higher in most cases the sorption capacity. In addition, the sorption capacity of pure ZrO₂ materials increases linearly with temperature from 260° C. to 340° C., beyond which the sorption capacity of the pure ZrO₂ materials falls again. At the highest measured temperature (420° C.) the sorption capacity is vanishingly small and the sulfur concentration is actually below the concentration of the starting materials.

It was also shown that a different performance (adsorbed amount of sulfur (ppm)) is obtained depending on the ZrO₂ material used and the sulfur species. It can therefore be concluded that while ZrO₂ materials are generally suitable for the adsorption of sulfur species the material must be selected according to the sulfur contamination.

The CeO₂/ZrO₂ materials exhibit the same trend with increasing temperature as the pure ZrO₂ materials. However, the sorption capacity for the CeO₂/ZrO₂ materials is much higher than for the pure ZrO₂ materials. In addition, the sorption capacity of the CeO₂/ZrO₂ materials increases continuously up to a temperature of 420° C., in contrast to the pure ZrO₂ materials.

1.-14. (canceled)

15. A process for purifying corrosive process gases containing sulfur compounds, wherein a gas stream comprising corrosive gases is in a sorption phase passed over an inorganic sorption material which takes up at least one of the sorbable sulfur-containing components on the sorption material to discharge the gas stream depleted of sulfur compounds.

16. The process as claimed in claim 15, wherein the sulfur compounds comprise one or more compounds selected from the group consisting of SOₓ, H₂S, CS₂, SOCl₂, S2Cl₂, SCl₂, COS and mercaptans.

17. The process as claimed in claim 15, wherein the sulfur compounds are present as trace gas in a concentration of not more than 10 ppm.

18. The process as claimed in claim 15, wherein the sorption material comprises as the active component at least one oxide or mixed oxide of cerium and/or zirconium and/or titanium.

19. The process as claimed in claim 15, wherein the sorption material is supported on a support material chemically resistant to hydrogen chloride, wherein the support material and any active component of the sorption material are different.

20. The process as claimed in claim 15, wherein the corrosive process gas comprises at least hydrogen chloride or hydrogen chloride and chlorine as the corrosive component.

21. The process as claimed in claim 20, wherein gas stream depleted of sulfur compounds is sent to a downstream catalytic process.

22. The process as claimed in claim 20, wherein the gas purification of the corrosive process gas is performed in a reaction zone arranged in a reactor which is separate from a downstream further reactor and whose temperature and/or pressure may be controlled independently of the further reactor.

23. The process as claimed in claim 20, wherein gas purification of the corrosive process gas is performed in a reaction zone arranged in a reactor having a plurality of reaction zones, wherein the reaction zone for gas purification is separate from at least one further downstream reaction zone for the gas phase reaction and the temperature and/or the pressure in the reaction zone for gas purification may be controlled independently of the downstream reaction zone.

24. The process as claimed in claim 15, wherein the sorption medium comprises a supported cerium oxide catalyst which is obtained when a cerium compound is applied to the support by means of dry impregnation and the impregnated support is subsequently dried and calcinated at elevated temperature.

25. The process as claimed in claim 15, wherein the purification of the corrosive process gas is effected at a temperature of not more than 420° C.

26. The process as claimed in claim 15, wherein the purification of the corrosive process gas is effected at a pressure of at least 1013 hPa.

27. The process as claimed in claim 15, wherein the gas stream depleted of sulfur compounds has a residual content of sulfur compounds of not more than 0.05 ppm.

28. A method comprising utilizing a sorption material comprising as an active component at least one oxide or mixed oxide of cerium and/or zirconium, and removing sulfur compounds from corrosive process gas containing sulfur compounds.
